(19) United States
(12) Patent Application Publication
(10) Pub. No.: US 2026/0348870 A1
(43) Pub. Date: Nov. 5, 2026

(54) DEVICE FOR DETECTING DEFECTS IN A PACKAGING UNIT AND/OR A PRODUCT

(71) Applicant: MULTIVAC MARKING & INSPECTION GMBH & CO. KG, Enger (DE)

(72) Inventors: Daniel SIEKMANN, Enger (DE); Dennis ISAAK, Bielefeld (DE)

(73) Assignee: MULTIVAC MARKING & INSPECTION GMBH & CO. KG, Enger (DE)

(21) Appl. No.: 19/662,833

(22) Filed: Apr. 29, 2026

(30) Foreign Application Priority Data
Apr. 30, 2025 (DE) 102025116757.5

(51) Int. Cl. G01N 21/90; G06T 7/00; G06T 7/143

(52) U.S. Cl. CPC G01N 21/90; G06T 7/0008; G06T 7/143; G01N 2201/0438; G01N 2201/0634; G06T 2207/10048; G06T 2207/20084

(57) ABSTRACT

A device for detecting defects in a packaging unit and/or product includes an infrared light source, infrared detector, and evaluation unit. The infrared detector and light source are arranged such that the detector can capture an image of a packaging unit and/or product in reflected light and/or transmitted light. The evaluation unit is to determine a probability image based on the image. The probability image associates a probability value with regions of the image indicative of a presence of a defect in the regions. The evaluation unit is to evaluate the probability image using a region detection algorithm and determine whether a group of contiguous regions has, for each region, a probability value above a threshold value, and output information indicative of a defect when at least one group of contiguous regions is present for which each region has a probability value above the threshold value.

### CROSS-REFERENCE TO RELATED APPLICATIONS

This application claims foreign priority benefits under 35 U.S.C. §119(a)-(d) to German Patent Application No. 102025116757.5 filed on Apr. 30, 2025, the disclosure of which is hereby incorporated herein by reference in its entirety.

### TECHNICAL FIELD

The present disclosure relates to a device for detecting defects in a packaging unit and/or a product as well as to a method for detecting defects in a packaging unit and/or a product.

### BACKGROUND

Devices and methods for inspecting packaging or products for defects are known from prior art. They typically comprise complex analyses such as, for example, hyperspectral analyses, radar imaging, or imaging methods using X-ray radiation. The devices used for this purpose, such as for example, X-ray emitters, are expensive. At the same time, the evaluation of the captured image information is difficult and prone to errors.

### SUMMARY

Based on known prior art, the technical object to be satisfied is therefore to specify a device and a method for detecting defects in packaging and/or products that can be realized inexpensively and at the same time detect defects as reliably as possible.

This object is satisfied according to the disclosure by the device for detecting defects in a packaging unit and/or a product as well as by a method for detecting defects in a packaging unit and/or a product as described herein. Advantageous further developments of the disclosure are covered by the dependent claims.

The device according to the disclosure for detecting defects in a packaging unit and/or a product comprises an infrared light source, an infrared detector, and an evaluation unit, wherein the infrared detector and the infrared light source are arranged such that the infrared detector can capture an image of a packaging unit and/or a product in reflected light and/or transmitted light, and wherein the evaluation unit is configured to determine a probability image based on the image, wherein the probability image associates a probability value with regions of the image that is indicative of the presence of a defect in the regions, and wherein the evaluation unit is configured to evaluate the probability image using a region detection algorithm and to determine whether a group of contiguous regions in the probability image has, for each region, a probability value above a threshold value, and to output information indicative of a defect if at least one group of contiguous regions is present in the probability image for which each region has a probability value above the threshold value.

The device being configured to detect defects in a packaging unit and/or a product is to be understood in the context of the disclosure such that the device can be used to detect defects in a packaging unit or defects in a product or defects in a packaging unit with a product introduced thereinto. Such defects can include, for example, defects of the product (insufficient quality of a food product or indications of spoilage of the food product) or defects in a closed packaging unit, such as for example, defects in a seal seam due to product being present in the region of the seal seam or other contaminations being present in the region of the seal seam. However, the disclosure is not restricted with respect to the type of defects or the type of packaging or products.

The products can in principle be understood to be any random products. However in particular food products, such as for example, sliced sausage or sliced cheese as well as dough or products in the pharmaceutical industry, such as for example, tablets are preferred. The packaging units into which these products can be filled or introduced can comprise, for example, flexible packaging (in particular foil pouches) or at least partially rigid packaging units. Rigid packaging units, or partially rigid packaging units, are to be understood to be those packaging units that comprise at least one dimensionally stable part. An example of such a rigid packaging unit is a packaging unit that consists of a packaging tray made of plastic material and a sealing film. The packaging tray is in this case typically produced by deep-drawing and therefore substantially rigid, whereas the sealing film is flexible or less rigid.

The term probability image is not to be understood in the context of the disclosure to be an image such that the packaging unit or the product must be recognizable therein. Instead, the probability image is to be understood to be such a data structure that unambiguously associates a probability value for the presence of a defect with a region of the original image. For example, the probability image can be represented in the form of a matrix, wherein the entries of the matrix specify a probability value that can be unambiguously associated with a specific region of the captured image (for example, by specifying the row and column number in the matrix). In an example in which the probability image is a matrix that associates a probability value for the presence of a defect with each pixel of the original image, the product of the number of rows and the number of columns of the matrix is equal to the number of pixels of the image and the entries in the matrix correspond to the pixels of the original image with respect to their position.

However, the regions with which the probability image associates the probability value according to the disclosure for the presence of a defect need not be identical to pixels of the image, but can also comprise, for example, groups of pixels, such as for example, a rectangular or square group of pixels consisting of 4, 9, 16, or 25 pixels. In such a case, the number of rows and columns (when the probability image is represented as a matrix) is correspondingly smaller than the number of pixels of the original image (rows and columns), but still allows for unambiguous association of the probability value with groups of pixels, i.e. a region, of the image

It is not mandatory according to the disclosure (but can be provided) that the probability image associates probability values with every region of the original image. This therefore means, there is no region of the image to which no probability value is associated in the probability image. Instead, for example, only part of the image (for example, the one on which the product or the packaging unit was recognized during previous evaluation of the image) can be used to determine the probability image.

The region detection algorithm preferably processes only the probability image. A group of contiguous regions that are detected by the region detection algorithm is to be understood such that these regions are at least pairwise adjacent to one another in the probability image. In the above example of the probability image as a matrix, this means that a group of regions is to be understood to be those regions in which at least two regions each correspond to matrix entries that are directly adjacent. This applies, for example, to regions or elements of the matrix Aᵢⱼ and Aᵢⱼ₊₁, but not to regions Aᵢⱼ and Aᵢⱼ₊₂, since these are separated from one another by the region or matrix element Aᵢⱼ₊₁. To this extent, the region detection algorithm examines the probability image as to whether there are groups of regions that are contiguous and at the same time the threshold value for each of these regions is above a defined threshold value.

The threshold value is to be understood to be that value that is regarded to be indicative of a defect being present in the region at issue. If the probability values in the probability image are specified, for example, as numbers between 0 and 1, wherein 0 stands for no defect or a vanishing probability for the presence of a defect, respectively, and 1 stands for a very high probability for the presence of a defect in the respective region, the threshold value can be set, for example, to 0.7 or 0.8 or 0.9. However, the disclosure is not restricted with respect to the threshold value and the choice of the threshold value (as well as to the number of regions that must be present in the contiguous region) can depend on external conditions, such as for example, an intention to rather sort out packaging due to falsely positively detected defects (false positive detection), than to take the risk that a package is further used despite an undetected defect (false negative detection).

With the device according to the disclosure, two-stage determination of a defect is realized, in which first the probability image is determined, and then a region detection is performed in the probability image. This improves the reliability for detecting defects. Costs can be reduced with this configuration as well as with the use of an infrared image.

It can be provided that the evaluation unit for determining the probability image comprises a neural network, in particular a convolutional neural network.

A particularly suitable neural network for determining the probability image is the deep learning tool of MVTec Software GmbH. It is basically known and can be trained to detect defects by inputting suitable training data. It can preferably be provided that the neural network is trained exclusively with positive images, i.e. with images showing packaging units or products without defects. With this embodiment, particularly reliable detection of possible defects in the regions for generating the probability image can be realized.

Device according to claim 2, wherein the neural network is a neural network trained only on the basis of defect-free packaging and/or products.

With this embodiment, every deviation from defect-free packaging units/products is reliably detected by the neural network. As a result, false negative identifications (i.e. erroneously determining supposedly defect-free regions in the probability image) can be prevented.

It can be provided that the region detection algorithm is a blob algorithm. Blob algorithms are in principle known to the person skilled in the art. They are particularly suitable for identifying and evaluating contiguous regions according to certain criteria.

In one embodiment, it is provided that the defects comprise one of a defective part of a product, a defective part of a packaging unit, a defective seal seam. The present disclosure is particularly suitable for detecting such defects, which can in particular advantageously influence the further processing of products and/or packaging units.

The regions can be identical, wherein the regions are optionally 16 pixels, 9 pixels, 4 pixels, or 1 pixel in size. The specific choice of the size of the regions can be particularly advantageous when defects can be reliably detected by the neural network, for example, only with larger groups of pixels (larger regions) or when defects can be reliably identified even when considering individual pixels. That the regions have a size of pixels is to be understood such that a probability value is determined in the probability image for a contiguous group of pixels (thus for example rectangles or squares in the image).

It can be provided that the device comprises a transport device for transporting packaging and/or products and that the transport device is arranged and configured such that it guides packaging and/or products past the infrared light source and the infrared detector.

The transport device can be, for example, a conveyor belt on which the packaging and/or products are transported along a transport direction. Capturing the image by way of the infrared detector can be done either when transporting the packaging or product, or the transport device can be stopped for capturing the image. With this embodiment, a high throughput of packaging and/or products is possible.

In one embodiment it is provided that the infrared light source is a diffuse infrared light source or that the device comprises a diffuser to generate diffuse reflected light and/or backlight and/or that the infrared detector comprises a camera, in particular, a short-wave infrared camera (SWIR camera). By using a diffuse light source, or respectively a diffuser to generate diffuse reflected light and/or backlight, the occurrence of reflections caused by point light sources or infrared sources can be prevented in the captured image, SWIR cameras are particularly advantageous for the high-resolution capture of the necessary infrared images.

According to the disclosure, a method for detecting defects in a packaging unit and/or a product by way of a device is furthermore provided, the device comprising an infrared light source, an infrared detector, and an evaluation unit, wherein the infrared detector and the infrared light source are arranged such that the infrared detector can capture an image of a packaging unit and/or a product in reflected light and/or transmitted light, and the method comprises determining a probability image based on the image using the evaluation unit, wherein the probability image associates a probability value with regions of the image that is indicative of the presence of a defect in the regions, and evaluating by way of the evaluation unit the probability image using a region detection algorithm of the evaluation unit and determining whether a group of contiguous regions in the probability image has, for each region, a probability value above a threshold value, outputting information indicative of a defect if at least one group of contiguous regions is present in the probability image for which each region has a probability value above the threshold value.

Inexpensive and at the same time reliable detection of defects is possible with this method.

It can be provided that the evaluation unit for determining the probability image comprises a neural network, in particular a convolutional neural network, wherein optionally the neural network is a neural network trained only on the basis of defect-free packaging units. With this neural network, the probability image can be generated with high accuracy.

The region detection algorithm can be a blob algorithm. A blob algorithm is particularly advantageously suitable for detecting contiguous regions based on certain criteria, presently of exceeding a threshold value.

It can be provided that the defects comprise one of a defective part of a product, a defective part of a packaging unit, a defective seal seam. The disclosure can thereby be advantageously applied to the food industry and the pharmaceutical industry.

The regions can be identical, wherein the regions are optionally 16 pixels, 9 pixels, 4 pixels, or 1 pixel in size. With this embodiment, demand-dependent reliable detection of regions that possibly have defects is possible.

It can be provided in one embodiment that the device comprises a transport device for transporting packaging and/or products and that the transport device is arranged and configured such that it guides packaging and/or products past the infrared light source and the infrared detector. As a result, the throughput can be achieved with simultaneously reliable detection of defects.

It is provided in one embodiment that the infrared light source is a diffuse infrared light source or that the device comprises a diffuser to generate diffuse reflected light and/or backlight and/or that the infrared detector comprises a camera, in particular, a short-wave infrared camera (SWIR camera). With this embodiment, high-quality images can be generated, which can improve the subsequent detection of defects.

### BRIEF DESCRIPTION OF THE DRAWINGS

FIG. 1 shows a device for detecting defects in a packaging unit and/or a product according to an embodiment.

FIG. 2 shows a flow diagram of a method for detecting defects in a packaging unit and/or a product.

### DETAILED DESCRIPTION

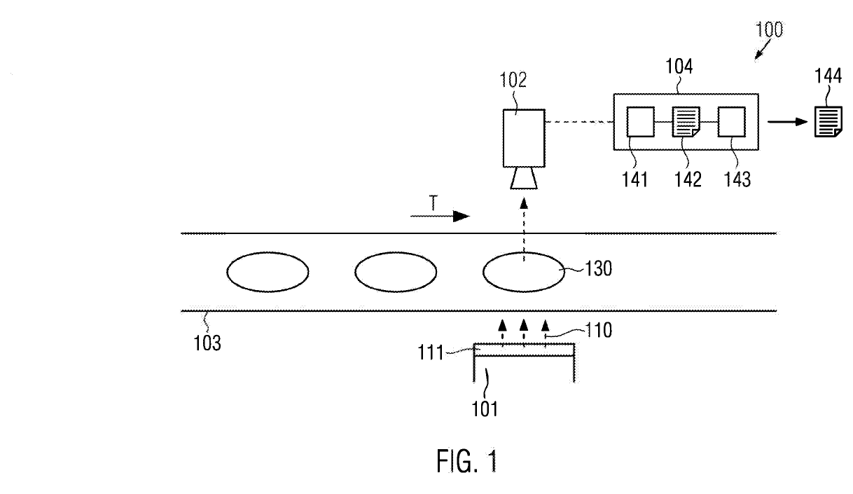

FIG. 1 shows a device 100 for detecting defects in a packaging unit and/or a product. Device 100 comprises an infrared light source 101 with which infrared light 110 can be emitted in the direction of a product and/or a packaging unit 130. Device 100 further comprises an infrared detector 102 that can detect the infrared light emitted and/or reflected by the packaging unit and/or the product 130, so as to generate an image, in particular an infrared image.

While the disclosure is not restricted to specific products or packaging, reference will be made hereinafter to the processing of an image of a product solely for the purpose of simpler description. It is understood that all the embodiments described in this context are also applicable to packaging units or packaging units with a product filled thereinto and are accordingly also explicitly provided for.

Device 100 can comprise a transport device 103 for the purpose of transporting products 130. Transport device 103 can be configured, for example, as a conveyor belt on which products 130 can be transported along a conveying direction T. However, transport device 103 is not restricted in this respect.

According to the disclosure, the device further comprises an evaluation unit 104 (for example in the form of a computer with an associated processor and memory with suitable program instructions for execution by the processor), with which an image captured by the infrared detector in reflected light and/or transmitted light (depending on the configuration of the infrared light source and the positioning thereof relative to the product and the infrared detector) can be evaluated. For this purpose, the evaluation unit first generates a probability image 142 based on the image captured. The probability image associates a probability value with regions of the image. Probability image 142 is therefore not necessarily identical to the image nor does it comprise its original image information. Instead, the probability image can be a combination of the image and a further data structure (in particular a matrix that can be stored, for example, analogously to the color information of the image in a further channel of the image or can be present as a separate data structure) in which probability values (for example, in the form of values from 0 to 255) are associated with regions, such as, for example, individual pixels or groups of pixels (for example, 4 pixels, 9 pixels, or 16 pixels), of the image.

To generate this probability image, evaluation unit 104 can comprise, for example, a neural network 141, in particular a convolutional neural network. It can be specifically trained to generate the probability image from an image of product 130. In the probability image, probability values associated with respective regions of the image correspond to a probability that a defect is present in the region at issue. The defect can be, for example, a defect in the packaging unit or a defect in the product or a defect in a packaging unit with a product filled thereinto. For example, the defect can be a defect in a seal seam of a packaging unit that is basically closed with a product filled thereinto. Defects in the seal seam can occur by way of example but not exclusively due to the sealing not being completed or performed as intended, or due to a product, such as for example, a part of a sausage slice, having been incorrectly positioned in the packaging unit and therefore having been positioned in the region of the seal seam to be produced during the sealing process. This prevents the sealing process at that location and a defect is created that can be detected in the infrared image.

In this way, the evaluation unit generates a data structure based on the original image (for example in the form of a matrix) in which probability values for the possible presence of a defect are unambiguously associated with regions of the original image. In addition to the probability value, the matrix can in each entry additionally contain a score that indicates, for example, the reliability in determining the probability value. However, this is not mandatory. As described, the probability image can have the form of a matrix A, wherein the matrix entries Aᵢⱼ contain a probability value (and optionally a score). Each value Aᵢⱼ of the matrix then represents a region of the original image and unambiguously associates therewith a probability value for the presence of a defect in that region.

Evaluation unit 104 furthermore comprises a region detection algorithm 143, such as for example, a blob algorithm. Probability image 142 is made available to this region detection algorithm for further evaluation. According to the disclosure, the region detection algorithm can then determine based on the probability image whether a group of contiguous regions exists (i.e., regions of the original image with which probability values are respectively associated in the probability image) in which each region, i.e., each region of the contiguous regions, has a probability value above a threshold value. The region detection algorithm can therefore examine whether contiguous or adjacent entries of matrix A each have probability values that are above a threshold value.

If the evaluation unit determines by way of the region detection algorithm that such a group of contiguous regions exists for which the probability values are above a threshold value, the evaluation unit can then detect that a defect is actually present and/or that it has a size that is relevant for further treatment of the product (for example, making it necessary to sort out the product, such as by any type of sorter, e.g., pusher/paddle sorter, pop-up sorter, diverters/gates, activated roller belt, air jets, etc.). Evaluation unit 104 can then output information 144 that is indicative of the presence of a defect in the product. Information 144 can be output, for example, as a screen on a display or can also be transmitted to another device (e.g., a sorter) in the form of a control command. The other device can then be controlled, for example, based on this control command to reject further processing of the product for which the presence of a defect has been detected or to not carry out further processing of this product.

In order to enable detection of potential defects in the image of the product 130 as reliably as possible, it can advantageously be provided that infrared light source 101 is a diffuse infrared light source. This prevents the image from having reflections (excessively bright or excessively dark areas in the infrared image) when the image is being created which when generating the probability image could erroneously be identified as regions representing a defect. If a diffuse infrared light source 101 is not provided, it can alternatively be provided that a non-diffuse infrared light source is associated with a diffuser 111 that converts the infrared radiation emitted by the infrared light source into diffuse infrared radiation 110 before it passes the product and is detected by the infrared detector.

In FIG. 1, the infrared light source is arranged on the side of the infrared detector 102 disposed opposite the product. However, this arrangement is not mandatory like that. The assembly shown in FIG. 1 causes the product to be detected by the infrared detector in transmitted light. To ensure this, transport device 103 can be configured as a transparent (at least transparent to infrared radiation) transport device or can comprise a region that is transparent to infrared radiation so that the irradiation of the products in transmitted light is possible.

Alternatively it can also be provided (presently not shown) that the infrared light source is arranged on the same side of the product as infrared detector 102. In this case the infrared light source is arranged such that it emits the infrared light in the direction of product 130 and the reflected infrared light can be captured by infrared detector 102.

The infrared detector can comprise in particular a camera. An SWIR camera is particularly preferred so that well-resolved infrared images can be generated therewith at low costs.

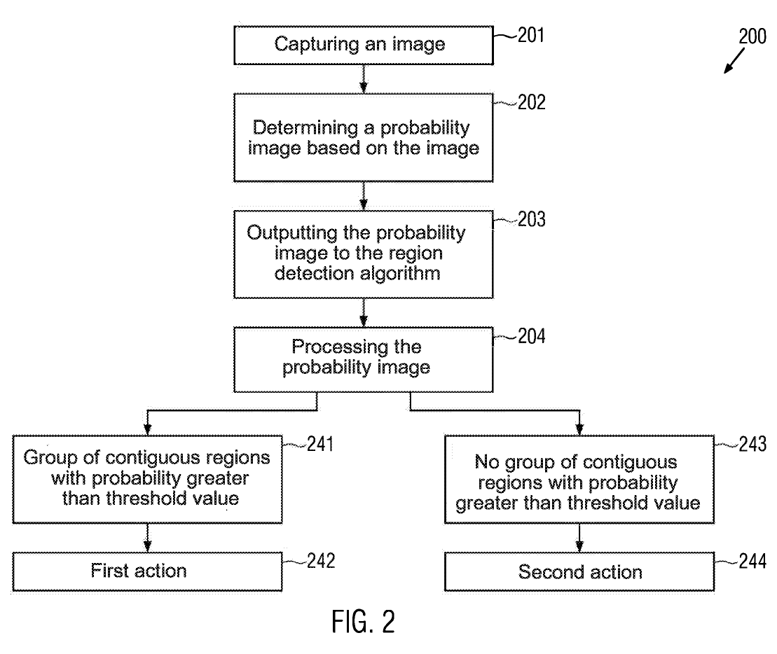

FIG. 2 shows a flow diagram of an embodiment of a method 200 for determining defects in a packaging unit and/or a product. As already set out above, reference shall be made hereinafter only to determining and processing an image of a product, whereas the disclosure is not restricted in this respect and correspondingly also comprises capturing an image of a packaging unit and/or a packaging unit with product filled thereinto.

The method begins with a step 201 in which an image of a product is captured in infrared light. As already described, this can take place either in backlight or reflected light, and the disclosure is not restricted in this respect. The resolution of the image is in principle arbitrary, but can be as high as possible, for example, 1024 x 768 pixels or 2048 x 1080 pixels or similar.

This image is then made available to the evaluation unit which in step 202 determines a probability image based on the image. As already described, this probability image is not necessarily an image whose image information is still identical at least in part to the originally captured image. Instead, the probability image can be present in the form of any data structure, such as for example, a matrix. The information of the probability image comprises at least one probability value that is associated with a specific region of the original image. For example, the data structure can associate a probability value with each pixel of the image. Alternatively, the data structure or the probability image can also associate a probability value with a respective partial region of the image. The partial region can comprise a plurality of pixels of the image, such as for example, 4 pixels, 9 pixels, or 16 pixels. A probability value is then jointly associated with them in the probability image. The probability image is constructed at least such that each probability value in the probability image is associated with a specific region of the image (in particular its position). If the image consists, for example, of a matrix of pixels with pixel values Bᵢⱼ, then the probability image in the representation of a matrix can comprise matrix values Aᵢⱼ, wherein the indices i, j of the probability image are associated with the indices i, j of the pixels of the image. That therefore means that, "pixels" in the form of probability values in the same arrangement of the pixels of the original image are present in the probability image for each corresponding pixel of the image. This allows for later detection of regions of the image that indicate a defect, without the originally captured image information still being necessary for this.

The probability image is then passed to the region detection algorithm in step 203. As already described, the region detection algorithm can be configured as a blob algorithm. The region detection algorithm processes the probability image in step 204. For this purpose, the region detection algorithm examines whether regions exist in the probability image that are contiguous and for each region of this group of regions the associated probability value is greater or less than a predefined threshold value.

In the context of the preceding example of the probability image as a matrix, the regions are matrix entries Aᵢⱼ of the probability image. Contiguous regions in the probability image then arise from matrix entries that are each at least pairwise adjacent. Starting from a matrix entry Aᵢⱼ, adjacent regions or matrix entries in the context of one embodiment are those with index i±1,j or i,j±1. Entries of the form A_{i±1j±1} can also be regarded as being adjacent, but are offset relative to the entry Aᵢⱼ in the diagonal of the matrix. In the original image, this means that these regions are only contiguous at a corner.

As an alternative to each of the regions having a probability value greater than the threshold value, it can also be provided that an average probability value of a contiguous group of regions in the probability image is greater than a given threshold value.

If the region detection algorithm detects a group of contiguous regions with a probability value greater than the corresponding threshold value (step 241), a first action 242 can take place. This first action can be in particular the evaluation unit associating the presence of a defect with this group of contiguous regions. Additionally, this information can be, for example, output to an operator so that the operator can detect that a product has a defect. The operator can then, for example, remove this product from the transport device or operate a device (e.g., a sorter) that removes the respective defective product from the transport device.

Alternatively, the information regarding the detected defect can also be used as a control signal for a device (e.g., a sorter) that can remove the defective product from the transport device.

It is understood that the region detection algorithm can also detect several groups of contiguous regions for which the probability value is above a threshold value. This ultimately means that a product has several defects that are detected by the region detection algorithm. This does not change the further procedure, in particular the execution of first action 242. However, it can be provided that the evaluation unit stores the occurrence of defects and the number thereof per product and evaluates this over time. If a temporal evaluation detects, for example, that the frequency of defects and/or the number of defects at products increases over time (for example a first number of products had on average a defect every hundredth packaging unit, but a second number of products examined at a later point in time had on average a defect every fifty products or two defects every twenty products), then the evaluation unit can also output this information to an operator, for example, as an average value for the determination of defects in a product and/or as an average value for the number of defects per product. The operator can then, for example, determine whether a deterioration has occurred in the operation of a device arranged upstream of the device for detecting defects and carry out corresponding steps of rectification (for example, maintenance work or repair work). The operator can also be instructed to do so by the evaluation unit by way of corresponding information.

If on the other hand the region detection algorithm detects for a product no group of contiguous regions whose respective probability values are greater than the threshold value or whose average probability value for the presence of a defect is greater than a corresponding threshold value (step 243), then a second action 244 can take place. This second action 244 can comprise, for example, an updated display to an operator that the operation of the device is functioning properly. However, it can also be provided that second action 244 does not comprise an actual action, but simply causes the operation to continue.

The method described in the context of FIG. 2 is preferably carried out for each product that is guided past the infrared detector so that each product is examined for defects.

It has been shown that for preventing false negative detections (i.e. the failure to detect defects in the product even though they are present), a neural network can advantageously be trained exclusively with defect-free products or images of such products. Deviations from such defect-free products are then detected with particular reliability by the trained neural network.

Whether the regions then actually are defects is then examined by the downstream evaluation of the probability image using the region detection algorithm. Because the latter examines a region of the original image that is larger than compared to the probability image for any deviations (since groups of contiguous regions in the probability image are identified).

What is claimed is:

1. A device for detecting defects in a packaging unit and/or a product, the device comprising:
an infrared light source,
an infrared detector, and
an evaluation unit,
wherein the infrared detector and the infrared light source are arranged such that, in operation, the infrared detector captures an image of a packaging unit and/or a product in reflected light and/or transmitted light, and
wherein the evaluation unit is configured to determine a probability image based on the image, wherein the probability image associates a probability value with regions of the image that is indicative of a presence of a defect in the regions, and wherein the evaluation unit is configured to evaluate the probability image by a region detection algorithm and to determine whether a group of contiguous regions in the probability image has, for each region, a probability value above a threshold value, and to output information indicative of a defect when at least one group of contiguous regions is present in the probability image for which each region has a probability value above the threshold value.

2. The device according to claim 1, wherein the evaluation unit for determining the probability image comprises a convolutional neural network.

3. The device according to claim 2, wherein the convolutional neural network is trained only on the basis of defect-free packaging units and/or products.

4. The device according to claim 1, wherein the region detection algorithm is a blob algorithm.

5. The device according to claim 1, wherein the defects comprise one of a defective part of a product, a defective part of a packaging unit, or a defective seal seam.

6. The device according to claim 1, wherein the regions are identical, wherein the regions are 16 pixels, 9 pixels, 4 pixels, or 1 pixel in size.

7. The device according to claim 1, wherein the device comprises a transport device for transporting a packaging unit and/or products and wherein the transport device is arranged and configured such that the transport device guides packaging and/or products past the infrared light source and the infrared detector.

8. The device according to claim 1, wherein the infrared light source is a diffuse infrared light source or wherein the device comprises a diffuser to generate diffuse reflected light and/or backlight; and/or
wherein the infrared detector comprises a short-wave infrared camera.

9. The device according to claim 1, wherein the evaluation unit is further configured to control another device in response to information indicative of a defect such that processing of the packaging unit and/or product is rejected.

10. The device according to claim 9, wherein the evaluation unit is further configured to cause processing of the packaging unit and/or product to continue in an absence of information indicative of a defect.

11. A method for detecting defects in a packaging unit and/or a product by way of a device, the device comprising an infrared light source, an infrared detector, and an evaluation unit, the method comprising:
capturing an image of a packaging unit and/or a product in reflected light and/or transmitted light
determining a probability image based on the image using the evaluation unit, wherein the probability image associates a probability value with regions of the image that is indicative of the presence of a defect in the regions,
evaluating, by the evaluation unit, the probability image using a region detection algorithm of the evaluation unit and determining whether a group of contiguous regions in the probability image has, for each region, a probability value above a threshold value, and
outputting information indicative of a defect when at least one group of contiguous regions is present in the probability image for which each region has a probability value above the threshold value.

12. The method according to claim 9, wherein the evaluation unit for determining the probability image comprises a convolutional neural network, wherein the convolutional neural network is trained only on the basis of defect-free packaging units.

13. The method according to claim 10, wherein the region detection algorithm is a blob algorithm.

14. The method according to claim 10, wherein the defects comprise one of a defective part of a product, a defective part of a packaging unit, or a defective seal seam.

15. The method according to claim 10, wherein the regions are identical, wherein the regions are 16 pixels, 9 pixels, 4 pixels, or 1 pixel in size.

16. The method according to claim 10, wherein the device comprises a transport device for transporting packaging and/or products and wherein the transport device guides packaging and/or products past infrared light source and the infrared detector.

17. The method according to claim 10, wherein the infrared light source is a diffuse infrared light source or wherein the device comprises a diffuser to generate diffuse reflected light and/or backlight; and/or
wherein the infrared detector comprises a short-wave infrared camera.

18. The method of claim 11 further comprising rejecting processing of the packaging unit and/or product in response to information indicative of a defect.

19. The method of claim 18 further comprising continuing processing of the packaging unit and/or product in an absence of information indicative of a defect.
